(19) United States
(12) Patent Application Publication
(10) Pub. No.: US 2026/0277141 A1
(43) Pub. Date: Sep. 17, 2026

(54) IMAGE FORMING APPARATUS AND IMAGE FORMING METHOD

(71) Applicants: Takamasa HASE, Kanagawa (JP); Arinobu YOSHIURA, Kanagawa (JP); Daisuke INOUE, Tokyo (JP); Shogo NAKAMOTO, Kanagawa (JP)

(72) Inventors: Takamasa HASE, Kanagawa (JP); Arinobu YOSHIURA, Kanagawa (JP); Daisuke INOUE, Tokyo (JP); Shogo NAKAMOTO, Kanagawa (JP)

(73) Assignee: ETRIA CO., LTD., Yokohama (JP)

(21) Appl. No.: 19/539,618

(22) Filed: Feb. 13, 2026

(30) Foreign Application Priority Data
Mar. 13, 2025 (JP) 2025-040438

(51) Int. Cl. G03G 15/20; G03G 15/00

(52) U.S. Cl. CPC G03G 15/205; G03G 15/2064; G03G 15/5029; G03G 2215/00734; G03G 2215/00738; G03G 2215/00759

(57) ABSTRACT

An image forming apparatus includes a fixing device that fixes toner on a recording medium to form a toner image and processing circuitry. The processing circuitry receives and analyzes print data in a monochrome mode to generate image data. The print data includes a drawing command. The processing circuitry calculates an image area rate per page of the recording medium based on the print data in the monochrome mode, determines that the image area rate is not greater than a predetermined value, determines a preset fixing temperature of the fixing device according to the image area rate, and controls the fixing device to fix the toner on the recording medium according to the image data.

### CROSS-REFERENCE TO RELATED APPLICATION

This patent application is based on and claims priority pursuant to 35 U.S.C. § 119(a) to Japanese Patent Application No. 2025-040438, filed on Mar. 13, 2025, in the Japan Patent Office, the entire disclosure of which is hereby incorporated by reference herein.

### BACKGROUND

### Technical Field

The present disclosure relates to an image forming apparatus and an image forming method, and more particularly, to an image forming apparatus and an image forming method performed by the image forming apparatus.

### Related Art

Related-art image forming apparatuses, such as copiers, facsimile machines, printers, and multifunction peripherals (MFP) having two or more of copying, printing, scanning, facsimile, plotter, and other functions, typically form an image on a recording medium according to image data by electrophotography.

Such image forming apparatuses include a fixing device that fixes a toner image on a recording medium such as a sheet (e.g., paper). The toner image on the sheet is made of toner in an amount that varies depending on an image pattern. The fixing device includes a heater that heats the sheet to fix the toner image thereon. The heater supplies heat in an amount that varies depending on the image pattern. In a case that the image forming apparatus forms a color toner image, the image forming apparatus determines a preset fixing temperature at which the fixing device fixes the color toner image on a sheet according to a maximum superimposing rate of yellow, magenta, cyan, and black toner images superimposed on the sheet to form the color toner image. Conversely, in a case that the image forming apparatus forms a monochrome toner image or in a case that the image forming apparatus is a monochrome image forming apparatus, the image forming apparatus determines the preset fixing temperature according to an image area rate of a toner image in a single color, that is, a black toner image, on a sheet.

As the image area rate of the toner image on the sheet increases, an amount of heat supplied to the sheet to fix the toner image thereon increases. Conversely, as the image area rate decreases, heat is conducted through the sheet in an in-plane direction thereof effectively. Thus, the fixing device fixes a toner image having a decreased image area rate at a fixing temperature lower than a fixing temperature of a toner image having an increased image area rate.

In a case that the image forming apparatus forms a toner image having an image area rate that is maximum (hereinafter also referred to as a maximum image area rate), the image forming apparatus determines a fixing temperature at which the fixing device fixes the toner image on a sheet properly. However, in general printing, the image forming apparatus forms the toner image having the decreased image area rate. Hence, in general printing, the image forming apparatus may set a preset fixing temperature that is unnecessarily higher than a fixing temperature at which the toner image having the decreased image area rate is fixed on the sheet. Accordingly, the image forming apparatus may have disadvantages in view of energy saving, a generation amount of fine particles, and quality of the sheet such as curling of the sheet.

### SUMMARY

The present disclosure described herein provides an image forming apparatus that includes a fixing device that fixes toner on a recording medium to form a toner image and processing circuitry. The processing circuitry receives and analyzes print data in a monochrome mode to generate image data. The print data includes a drawing command. The processing circuitry calculates an image area rate per page of the recording medium based on the print data in the monochrome mode, determines that the image area rate is not greater than a predetermined value, determines a preset fixing temperature of the fixing device according to the image area rate, and controls the fixing device to fix the toner on the recording medium according to the image data.

The present disclosure described herein further provides an image forming apparatus that includes fixing means for fixing toner on a recording medium to form a toner image and control means. The control means receives and analyzes print data in a monochrome mode to generate image data. The print data includes a drawing command. The control means calculates an image area rate per page of the recording medium based on the print data in the monochrome mode, determines that the image area rate is not greater than a predetermined value, determines a preset fixing temperature of the fixing means according to the image area rate, and controls the fixing means to fix the toner on the recording medium according to the image data.

The present disclosure described herein further provides an image forming method that includes reading and analyzing print data, calculating an image area rate per page of a recording medium based on the print data, determining that the image area rate is not greater than a predetermined value, determining a preset fixing temperature at which a toner image is fixed on the recording medium according to the image area rate, and starting printing at the preset fixing temperature.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic cross-sectional view of an image forming apparatus according to an embodiment of the present disclosure;

FIG. 2 is a block diagram of the image forming apparatus depicted in FIG. 1;

FIG. 3 is a schematic cross-sectional view of a fixing device incorporated in the image forming apparatus depicted in FIG. 1;

FIG. 4A is a diagram of figures that have different halftone densities, respectively;

FIG. 4B is a diagram of square figures that form a grid;

FIG. 4C is a diagram of a halftone image and a region in which no toner image is formed;

FIG. 4D is a diagram of a solid image;

FIG. 4E is a diagram of an image framed with borders;

FIG. 5 is a diagram of images on a page;

FIG. 6 is a flowchart of processes of a control method performed by the image forming apparatus depicted in FIG. 1 according to a first embodiment of the present disclosure, as one example;

FIG. 7 is a flowchart of processes of a control method performed by the image forming apparatus depicted in FIG. 1 according to a second embodiment of the present disclosure, as one example;

FIG. 8 is a flowchart of processes of a control method performed by the image forming apparatus depicted in FIG. 1 according to a third embodiment of the present disclosure, as one example; and

FIG. 9 is a flowchart of processes of a control method performed by the image forming apparatus depicted in FIG. 1 according to a fourth embodiment of the present disclosure, as one example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

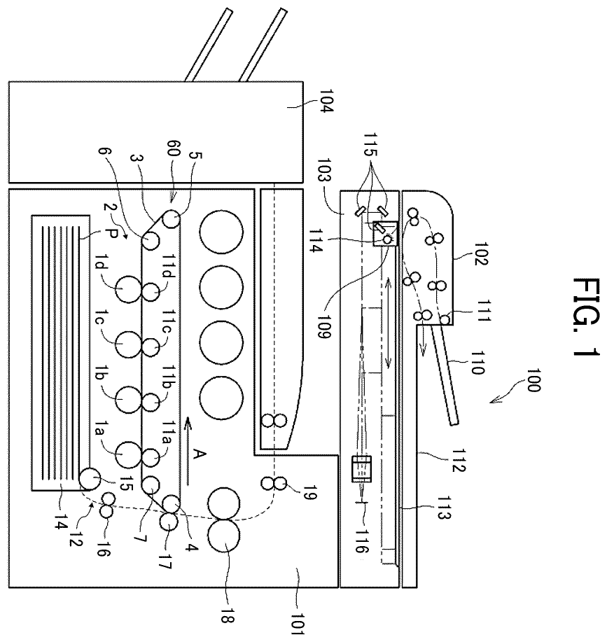

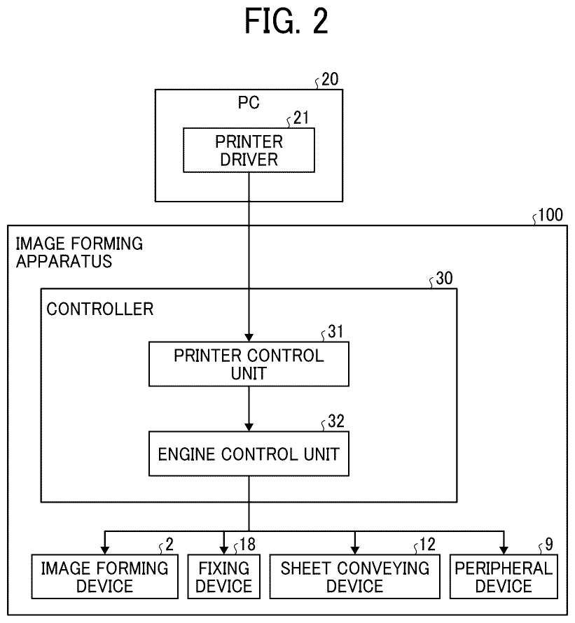

The following describes an embodiment of a multifunction peripheral (MFP) employing an electrophotographic method, as one example of an image forming apparatus according to an embodiment of the present disclosure. FIG. 1 is a schematic cross-sectional view of an image forming apparatus 100 according to an embodiment of the present disclosure. FIG. 2 is a block diagram of the image forming apparatus 100. As illustrated in FIG. 1, the image forming apparatus 100 includes a body 101, an automatic document feeder (ADF) 102, a scanner 103 serving as an image reader, and a finisher 104 serving as a post-processing apparatus. The body 101 may be combined with the scanner 103 or may be provided separately from the scanner 103.

The image forming apparatus 100 further includes a control panel. A user changes settings for recording sheets, copy image quality, scanning, and the like with the control panel. As illustrated in FIG. 2, the image forming apparatus 100 receives a print job sent from an external device, for example, a personal computer (PC) 20, and performs printing according to the print job.

As illustrated in FIG. 2, the image forming apparatus 100 further includes a controller 30, a sheet conveying device 12, a peripheral device 9, an image forming device 2, and a fixing device 18 in addition to the scanner 103, the ADF 102, and the finisher 104. The controller 30 includes a printer control unit 31 and an engine control unit 32. For example, the controller 30 is constructed of a central processing unit (CPU), a read only memory (ROM), a random access memory (RAM), and the like. According to a signal sent from the controller 30, the image forming device 2, the fixing device 18, and the sheet conveying device 12 perform printing in a print mode specified by a printer driver 21 of the PC 20. As illustrated in FIG. 1, the ADF 102 includes an original tray 110, a pickup roller 111, and an original output tray 112. An original is placed on the original tray 110. The pickup roller 111 picks up the original from the original tray 110. The original is ejected onto the original output tray 112.

As illustrated in FIG. 1, the scanner 103 includes a carriage 109, an exposure glass 113, a light source 114, a plurality of reflection mirrors 115, a photoelectric conversion element 116, and an analog-to-digital (A/D) converter. The carriage 109 moves in a horizontal direction indicated by a bidirectional arrow in FIG. 1. The carriage 109 accommodates the light source 114, such as a light-emitting diode (LED), that emits light onto the original through the exposure glass 113. The photoelectric conversion element 116 (e.g., a charge-coupled device (CCD) sensor) receives the light reflected by the original and converts the reflected light into an electric signal. The A/D converter converts the electric signal into digital data. The finisher 104 includes a stapler, a punch, and a folder that staples, punches, and folds recording sheets P serving as recording media, respectively, as post processes after image formation.

The stapler gathers and binds the recording sheets P ejected from the body 101 into one bundle of the recording sheets P in a predetermined number according to an instruction of the print job. The punch punches holes at predetermined positions on one or more recording sheets P ejected from the body 101 as a single recording sheet P or one bundle of the recording sheets P in a predetermined number according to an instruction of the print job.

The image forming device 2 disposed in the body 101 forms a toner image on a recording sheet P. The image forming device 2 includes four image bearers, that is, photoconductors 1a, 1b, 1c, and 1d serving as a first photoconductor, a second photoconductor, a third photoconductor, and a fourth photoconductor, respectively. The image forming device 2 disposed in the body 101 further includes an intermediate transfer device 60 that is disposed above the four photoconductors 1a, 1b, 1c, and 1d. The intermediate transfer device 60 serving as a belt device includes an intermediate transfer belt 3 serving as a belt.

Toner images in different colors are formed on the four photoconductors 1a, 1b, 1c, and 1d, respectively. According to the embodiment, black, cyan, magenta, and yellow toner images are formed on the four photoconductors 1a, 1b, 1c, and 1d, respectively. Each of the photoconductors 1a, 1b, 1c, and 1d depicted in FIG. 1 is drum-shaped. Alternatively, the image forming apparatus 100 may employ a photoconductor as an endless belt that is looped over a plurality of rollers and is driven and rotated.

The intermediate transfer belt 3 serving as an intermediate transferor is disposed opposite the photoconductors 1a, 1b, 1c, and 1d. FIG. 1 illustrates the four photoconductors 1a, 1b, 1c, and 1d that contact a surface of the intermediate transfer belt 3. As illustrated in FIG. 1, the intermediate transfer device 60 further includes a secondary transfer opposed roller 4, a tension roller 5, a backup roller 6, and an entry roller 7 serving as support rollers over which the intermediate transfer belt 3 is looped. The image forming apparatus 100 further includes a driver that drives and rotates one of the support rollers, that is, the secondary transfer opposed roller 4 serving as a driving roller. As the driver drives the secondary transfer opposed roller 4, the secondary transfer opposed roller 4 drives and rotates the intermediate transfer belt 3 in a rotation direction A in FIG. 1.

The intermediate transfer belt 3 may have a multilayer structure or a single-layer structure. In a case that the intermediate transfer belt 3 has the multilayer structure, the intermediate transfer belt 3 includes a base layer and a coating layer. For example, the base layer is made of a stretch resistant material such as fluororesin, a polyvinylidene fluoride (PVDF) sheet, and polyimide resin. The coating layer serves as a surface layer that has an enhanced smoothness and is made of fluororesin or the like. In a case that the intermediate transfer belt 3 has the single-layer structure, the intermediate transfer belt 3 is made of PVDF, polycarbonate (PC), polyimide, or the like.

A toner image is formed on each of the four photoconductors 1a, 1b, 1c, and 1d and is transferred onto the intermediate transfer belt 3 in a substantially identical method. However, a color of the toner image is different between the four photoconductors 1a, 1b, 1c, and 1d. Hence, the following describes formation of a yellow toner image on the photoconductor 1d and transfer of the yellow toner image onto the intermediate transfer belt 3. The photoconductor 1d that bears the yellow toner image is disposed upstream from the photoconductors 1c, 1b, and 1a in the rotation direction A of the intermediate transfer belt 3.

The image forming device 2 further includes a discharger and a charger. The photoconductor 1d used to form the yellow toner image rotates clockwise in FIG. 1. The discharger of the image forming device 2 irradiates a surface of the photoconductor 1d with light, initializing a surface electric potential of the photoconductor 1d. The charger uniformly charges the surface of the photoconductor 1d having the initialized surface electric potential with a predetermined polarity, that is, with a negative polarity according to the embodiment.

The image forming apparatus 100 further includes an exposure device. The exposure device emits a laser beam that is optically modulated onto the charged surface of the photoconductor 1d, forming an electrostatic latent image on the surface of the photoconductor 1d according to writing data. The image forming apparatus 100 depicted in FIG. 1 employs the exposure device including a laser writer that emits the laser beam. Alternatively, the image forming apparatus 100 may employ an exposure device including an LED array and an imaging device, for example.

The image forming device 2 further includes a developing device containing yellow toner. The developing device visualizes the electrostatic latent image formed on the photoconductor 1d as a yellow toner image. The intermediate transfer device 60 further includes a primary transfer roller 11d that is disposed opposite an inner circumferential face of the intermediate transfer belt 3 and disposed opposite the photoconductor 1d via the intermediate transfer belt 3. The primary transfer roller 11d is used to transfer the yellow toner image formed on the photoconductor 1d onto the intermediate transfer belt 3.

The primary transfer roller 11d contacts the inner circumferential face (e.g., a back face) of the intermediate transfer belt 3, forming a primary transfer nip between the photoconductor 1d and the intermediate transfer belt 3 properly. The primary transfer roller 11d is applied with a transfer voltage having a polarity (e.g., a positive polarity according to the embodiment) opposite to a polarity of charged toner of the yellow toner image formed on the photoconductor 1d.

Accordingly, a transfer electric field is formed between the photoconductor 1d and the intermediate transfer belt 3. The transfer electric field electrostatically transfers the yellow toner image formed on the photoconductor 1d onto the intermediate transfer belt 3 that is driven and rotated in synchronism with rotation of the photoconductor 1d. The image forming device 2 further includes a cleaner used to clean the photoconductor 1d. After the primary transfer roller 11d transfers the yellow toner image onto the intermediate transfer belt 3, the cleaner removes residual toner failed to be transferred onto the intermediate transfer belt 3 and therefore adhered to the surface of the photoconductor 1d therefrom. Thus, the cleaner cleans the surface of the photoconductor 1d.

The intermediate transfer device 60 further includes primary transfer rollers 11c, 11b, and 11a. Similarly, magenta, cyan, and black toner images are formed on other three photoconductors 1c, 1b, and 1a, respectively. The primary transfer rollers 11c, 11b, and 11a electrostatically transfer the magenta, cyan, and black toner images onto the intermediate transfer belt 3 such that the magenta, cyan, and black toner images are superimposed on the yellow toner image on the intermediate transfer belt 3 successively.

The image forming apparatus 100 has two driving modes, that is, a full color mode using toners in four colors (e.g., black, cyan, magenta, and yellow toners) and a monochrome mode using toner in a single color (e.g., black toner). In the full color mode, the intermediate transfer belt 3 contacts the four photoconductors 1a, 1b, 1c, and 1d so that the primary transfer rollers 11a, 11b, 11c, and 11d transfer the black, cyan, magenta, and yellow toner images onto the intermediate transfer belt 3.

Conversely, in the monochrome mode, the photoconductor 1a contacts the intermediate transfer belt 3 so that the primary transfer roller 11a transfers the black toner image onto the intermediate transfer belt 3. The three photoconductors 1b, 1c, and 1d used to form the cyan, magenta, and yellow toner images, respectively, do not contact the intermediate transfer belt 3. For example, the intermediate transfer device 60 further includes a contact and separation mechanism that separates the three primary transfer rollers 11b, 11c, and 11d from the photoconductors 1b, 1c, and 1d, respectively. In order to separate the intermediate transfer belt 3 precisely from the three photoconductors 1b, 1c, and 1d used to form the cyan, magenta, and yellow toner images, respectively, the backup roller 6 moves to change a profile of the intermediate transfer belt 3.

As illustrated in FIG. 1, the sheet conveying device 12 includes a sheet feeder 14 and a registration roller pair 16. The sheet feeder 14 is disposed in a lower portion of the body 101 and conveys recording sheets P. The sheet feeder 14 includes a feed roller 15. As the feed roller 15 rotates, the feed roller 15 picks up and feeds a recording sheet P serving as a recording medium upward in FIG. 1. The recording sheet P fed by the feed roller 15 strikes the registration roller pair 16 used to convey the recording sheet P and halts temporarily.

The image forming apparatus 100 further includes a secondary transfer roller 17. The intermediate transfer belt 3 includes a looped portion that is looped over the secondary transfer opposed roller 4. The looped portion contacts the secondary transfer roller 17 serving as a secondary transferor that is disposed opposite the looped portion. Thus, the intermediate transfer belt 3 and the secondary transfer roller 17 define a contact portion that forms a secondary transfer nip.

The registration roller pair 16 conveys the recording sheet P that strikes the registration roller pair 16 to the secondary transfer nip at a predetermined time. The secondary transfer roller 17 is applied with a predetermined transfer voltage that secondarily transfers the yellow, magenta, cyan, and black toner images transferred and superimposed on the intermediate transfer belt 3 onto the recording sheet P. Thus, a color toner image is formed on the recording sheet P.

The recording sheet P secondarily transferred with the color toner image is conveyed upward in FIG. 1 to the fixing device 18. As the recording sheet P is conveyed through the fixing device 18, the fixing device 18 fixes the color toner image on the recording sheet P under heat and pressure. The image forming apparatus 100 further includes a sheet output device that includes an output roller pair 19. The output roller pair 19 ejects the recording sheet P sent from the fixing device 18 onto an outside of the image forming apparatus 100. The recording sheet P is stacked on an output tray. The image forming apparatus 100 further includes a belt cleaner. After the secondary transfer roller 17 transfers the yellow, magenta, cyan, and black toner images onto the recording sheet P, toner in a slight amount remains on the intermediate transfer belt 3 as residual toner. The belt cleaner removes the residual toner from the intermediate transfer belt 3.

A description is provided of a construction of the fixing device 18 according to an embodiment of the present disclosure.

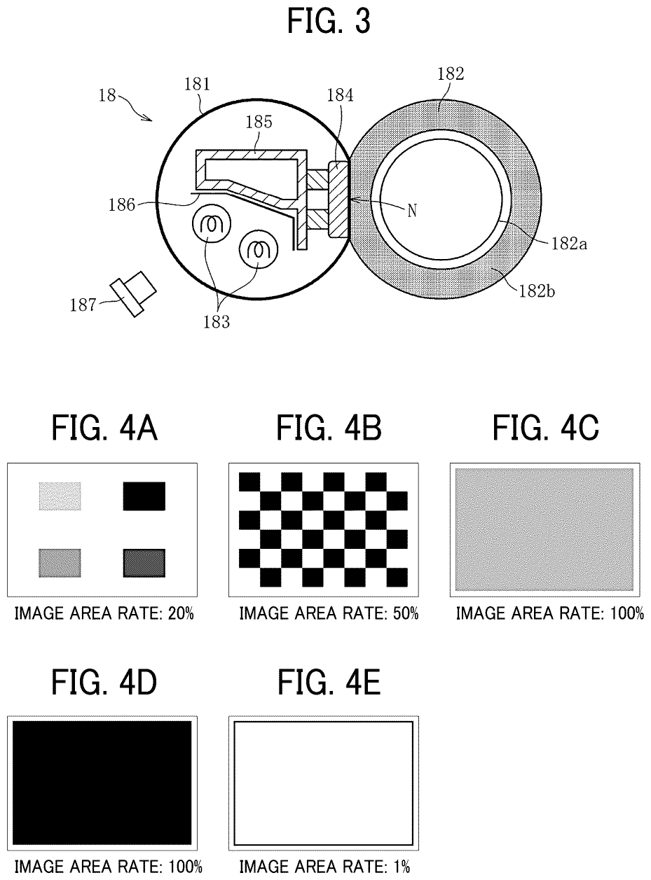

FIG. 3 is a schematic diagram of the fixing device 18 according to the embodiment of the present disclosure.

The fixing device 18 according to the embodiment includes an endless, fixing belt 181, a nip formation plate 184, a pressure roller 182, and two heaters 183. The nip formation plate 184 serves as a nip formation pad that is disposed opposite the pressure roller 182 via the fixing belt 181. The heaters 183 serve as heaters or heat sources that heat the fixing belt 181.

The nip formation plate 184 contacts an inner circumferential face of the fixing belt 181. The nip formation plate 184 and the pressure roller 182 sandwich the fixing belt 181. The fixing belt 181 includes a nip formation portion that contacts a nip formation face of the nip formation plate 184. The nip formation portion of the fixing belt 181 and the pressure roller 182 form a fixing nip N therebetween.

The fixing belt 181 is an endless belt or an endless film that is made of metal such as nickel and stainless used steel (SUS) or resin such as polyimide. The fixing belt 181 includes a base layer and a release layer. The release layer serves as a surface layer made of perfluoroalkoxy alkane (PFA), polytetrafluoroethylene (PTFE), or the like, facilitating separation of toner of the toner image on the recording sheet P from the fixing belt 181 and preventing the toner from adhering to the fixing belt 181.

Optionally, an elastic layer made of silicone rubber or the like may be interposed between the base layer and the release layer of the fixing belt 181. In a case that the fixing belt 181 does not incorporate the elastic layer, the fixing belt 181 has a decreased thermal capacity that improves fixing property of being heated quickly. However, slight surface asperities of the fixing belt 181 may generate an orange peel mark on a solid part of the toner image, causing the solid part of the toner image to suffer from uneven gloss (e.g., an orange peel image).

To address the circumstance, the fixing belt 181 preferably incorporates the elastic layer having a thickness of 100 μm or greater, for example. As the elastic layer deforms, the elastic layer absorbs the slight surface asperities of the fixing belt 181, preventing the orange peel image.

The heaters 183 are disposed opposite the inner circumferential face of the fixing belt 181 and heat the fixing belt 181 with radiant heat. The heaters 183 according to the embodiment include halogen heaters, respectively. However, a type, a number, and the like of the heaters 183 may be selected arbitrarily. For example, the heater 183 may be an induction heater (IH), a resistive heat generator, a carbon heater, or the like instead of the halogen heater.

The pressure roller 182 is an elastic roller that includes a core metal 182a, an elastic rubber layer 182b, and a release layer. The elastic rubber layer 182b surrounds the core metal 182a. The pressure roller 182 includes a surface layer having a hardness that is lower than a hardness of the nip formation face of the nip formation plate 184. The elastic rubber layer 182b of the pressure roller 182 may be made of solid rubber. However, the elastic rubber layer 182b is preferably made of sponge rubber.

The sponge rubber preferably enhances thermal insulation of the pressure roller 182, preventing the pressure roller 182 from drawing heat from the fixing belt 181. The release layer of the pressure roller 182 serves as the surface layer that facilitates separation of the recording sheet P from the pressure roller 182. The release layer is made of PFA, PTFE, or the like.

The fixing device 18 further includes a frame that supports a shaft of the pressure roller 182. The body 101 of the image forming apparatus 100 accommodates a driver such as a motor that generates a driving force. As the driving force is transmitted to the pressure roller 182 through a gear, the driving force drives and rotates the pressure roller 182. The driving force is transmitted from the pressure roller 182 to the fixing belt 181 at the fixing nip N, rotating the fixing belt 181 in accordance with rotation of the pressure roller 182. The fixing device 18 further includes flanges serving as holders that support the fixing belt 181 at both lateral ends of the fixing belt 181, respectively, in an axial direction thereof in a circumferential span of the fixing belt 181 other than the nip formation portion thereof that defines the fixing nip N. The flanges guide the fixing belt 181 that rotates.

As the fixing belt 181 rotates, the inner circumferential face of the fixing belt 181 slides over the nip formation face of the nip formation plate 184. The fixing device 18 may further include a slide aid such as a slide sheet that is interposed between the nip formation face of the nip formation plate 184 and the inner circumferential face of the fixing belt 181. The slide aid facilitates sliding of the fixing belt 181 over the nip formation plate 184.

The fixing device 18 further includes a stay 185 that mounts and supports the nip formation plate 184. The stay 185 prevents the nip formation plate 184 from being bent as the nip formation plate 184 receives pressure from the pressure roller 182. Thus, the stay 185 also causes the nip formation plate 184 to form the fixing nip N evenly in a width direction, that is, the axial direction, of the fixing belt 181.

As the stay 185 receives pressure from the pressure roller 182, the fixing nip N attains surface pressure with which the fixing belt 181 and the pressure roller 182 melt and fix toner of the toner image on the recording sheet P. The fixing device 18 further includes holders that support both lateral ends of the stay 185 in a longitudinal direction thereof, respectively. The stay 185 is secured to and positioned by the holders.

The stay 185 is machined by bending a plate made of iron or stainless steel, for example. Since the stay 185 is machined with an iron plate or an SUS plate having a thickness in a range of from approximately 2 mm to 4 mm, the stay 185 has an increased thermal capacity. Hence, the fixing device 18 according to the embodiment further includes a reflector 186 that is interposed between the heaters 183 and the stay 185. The reflector 186 reflects radiant heat and the like from the heaters 183, suppressing heating of the stay 185 with the radiant heat and the like and resultant waste of energy. Alternatively, instead of the reflector 186, a surface of the stay 185 may be treated with thermal insulation or specular surface finish.

The nip formation face of the nip formation plate 184 according to the embodiment is substantially planar. The nip formation face of the nip formation plate 184 has a hardness that is greater than a hardness of the elastic rubber layer 182b of the pressure roller 182. Hence, the elastic rubber layer 182b of the pressure roller 182 elastically deforms along the nip formation face of the nip formation plate 184.

Accordingly, the fixing nip N according to the embodiment is substantially planar along the nip formation face (e.g., a plane) of the nip formation plate 184. Alternatively, the nip formation face may not be planar precisely. If the nip formation face has a curvature that is sufficiently smaller than a curvature of a curved fixing nip formed between two rollers, the nip formation face may be slightly curved to define a projection or a recess.

The fixing device 18 according to the embodiment that has the construction described above incorporates the fixing belt 181 that has the decreased thermal capacity. Hence, the heaters 183 heat the fixing belt 181 efficiently in a shortened time. After the fixing device 18 is warmed up and the fixing belt 181 is heated to a predetermined fixing temperature, the image forming apparatus 100 starts image formation. The fixing device 18 according to the embodiment incorporates the fixing belt 181 having the decreased thermal capacity. Hence, the heaters 183 heat the fixing belt 181 to the fixing temperature in the shortened time, shortening a warm-up time.

The fixing device 18 further includes a thermopile 187 that detects a temperature of an outer circumferential face of the fixing belt 181. The controller 30 determines an amount of power to be supplied to the heaters 183 based on a temperature difference between the temperature of the fixing belt 181, that is feedbacked, and a target temperature. When the image forming apparatus 100 starts printing or warm-up, the controller 30 may input a predetermined amount of power to be supplied to the heaters 183. The heater 183 has a rated power of 1,200 W and a power supply voltage of 100 V. In a case that the heater 183 is supplied with power continuously, the heater 183 is applied with an electric current of 12 A with a power consumption of 1,200 W.

A description is provided of a configuration of a first comparative image forming apparatus.

For example, the first comparative image forming apparatus changes a fixing temperature at which a toner image is fixed on a sheet according to a number of colors of toner used to form the toner image, that is, according to whether the toner image is a monochrome toner image or a multi-color toner image.

A description is provided of a configuration of a second comparative image forming apparatus.

The second comparative image forming apparatus includes a scanner and a photoconductor. The scanner irradiates a surface of the photoconductor with a light beam that scans the surface of the photoconductor in a main scanning direction according to image data. The second comparative image forming apparatus divides the image data into a plurality of regions and analyzes a print coverage ratio. The second comparative image forming apparatus determines a fixing temperature based on a position in the main scanning direction and the print coverage ratio for each of the plurality of regions.

A description is provided of a configuration of a third comparative image forming apparatus.

The third comparative image forming apparatus includes a fixing device. The third comparative image forming apparatus calculates an adhesion amount of toner adhered to a sheet based on a print coverage ratio on the sheet. The third comparative image forming apparatus controls a temperature at which the fixing device heats the sheet based on the adhesion amount of the toner.

A description is provided of a control method performed by the image forming apparatus 100 according to a first embodiment of the present disclosure.

The image forming apparatus 100 according to the first embodiment of the present disclosure calculates an image area rate per page based on print data in the monochrome mode. In a case that the image area rate is not greater than a predetermined value, the image forming apparatus 100 determines a preset fixing temperature (e.g., a target fixing temperature) of the fixing device 18.

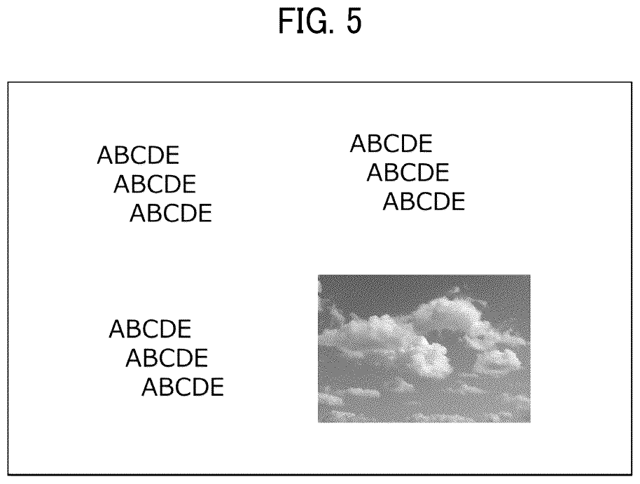

FIG. 4A is a diagram of figures that have different halftone densities, respectively. FIG. 4B is a diagram of square figures that form a grid. FIG. 4C is a diagram of a halftone image and a region in which no toner image is formed. FIG. 4D is a diagram of a solid image. FIG. 4E is a diagram of an image framed with borders. FIG. 5 is a diagram of images on a page.

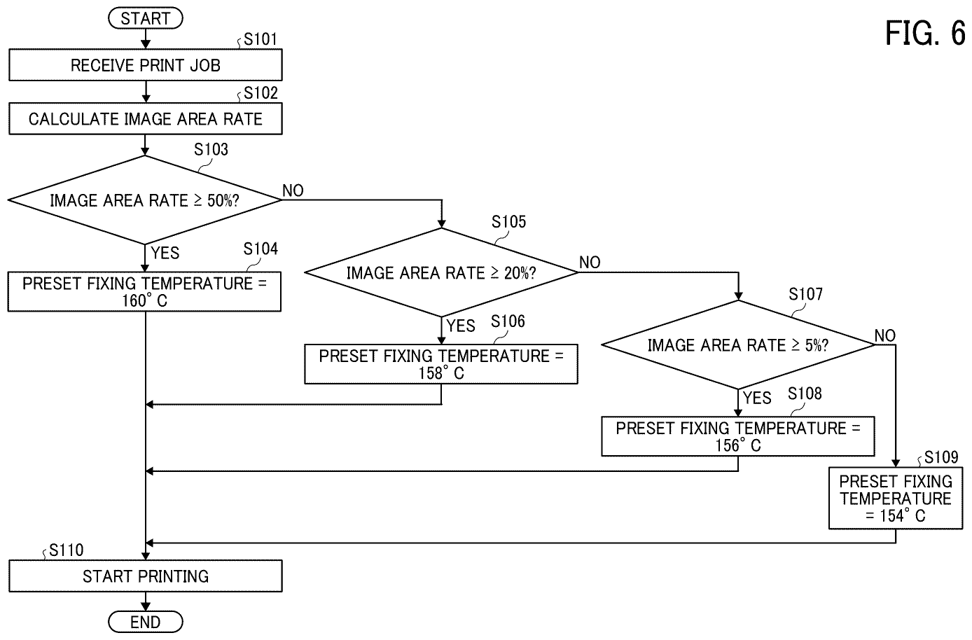

FIG. 6 is a flowchart of processes of the control method performed by the image forming apparatus 100 according to the first embodiment of the present disclosure, as one example. The image forming apparatus 100 according to the first embodiment of the present disclosure starts printing after steps S101 to S109.

In step S101, as the controller 30 depicted in FIG. 2 receives a print job (hereinafter referred to as print data or image data also) from the PC 20, the controller 30 reads and analyzes the print data. For example, the controller 30 determines whether the print data specifies the monochrome mode or the full color mode so that the image forming apparatus 100 depicted in FIG. 1 forms a toner image on a recording sheet P.

In step S102, the controller 30 calculates an image area rate on a page based on the analyzed image data.

As the image area rate decreases, a thermal capacity of toner of the toner image decreases, thus decreasing an amount of heat with which the fixing device 18 fixes the toner image on the recording sheet P serving as a recording medium. Even if the controller 30 decreases the preset fixing temperature, heat is conducted through the recording sheet P in an in-plane direction thereof, fixing the toner image on the recording sheet P.

The printer driver 21 installed in the PC 20 depicted in FIG. 2 generates the print data composed of drawing commands described in a page description language (PDL) and sends the print data to the printer control unit 31 of the controller 30 of the image forming apparatus 100 in step S101. The printer control unit 31 analyzes the print data. In a case that the printer control unit 31 determines that the print data specifies the monochrome mode, the printer control unit 31 calculates the image area rate on one page in step S102. The printer control unit 31 generates image data through drawing processing and sends the image data to the engine control unit 32 to form the toner image on the recording sheet P.

The drawing commands instruct drawing of characters, graphics, and images (e.g., photographs and images formed in formats such as bitmap (BMP), graphics interchange format (GIF), tagged image file format (TIFF), joint photographic experts group (JPEG), portable network graphics (PNG), raw image format (RAW), and scalable vector graphics (SVG)).

The engine control unit 32 controls the exposure device of the image forming apparatus 100 to emit a laser beam onto a photoconductor (e.g., the photoconductors 1a, 1b, 1c, and 1d) according to the image data, forming an electrostatic latent image on a surface of the photoconductor according to writing data.

The graphic denotes a format that represents an image as a group of figures such as a line, a square, a rectangle, a circle, an oval, and a curve. The image denotes a format that represents an image as a group of pixels assigned with data of color and density per pixel.

The controller 30 analyzes the image data generated by the drawing processing for each pixel and calculates the image area rate precisely. However, the controller 30 may suffer from an increased load and a decreased print speed. The drawing commands include image size data for the characters, the graphics, and the images. The controller 30 analyzes the image size data to calculate the image area rate. Hence, the controller 30 is imposed with a decreased load compared to a method in which the controller 30 analyzes the image data for each pixel.

In a case that the recording sheet P bears a toner image formed with an increased amount of toner, the toner image has an increased thermal capacity. Heat conducts to an end of the toner image in the in-plane direction of the recording sheet P. However, heat does not conduct to an interior of the toner image easily. Conversely, in a case that the recording sheet P bears a toner image formed with a decreased amount of toner, the toner image has a decreased thermal capacity. Heat conducts sufficiently also to the interior of the toner image in the in-plane direction of the recording sheet P. Accordingly, even if the controller 30 decreases a target fixing temperature, the fixing device 18 fixes the toner image on the recording sheet P properly.

With respect to the characters, the graphics, and the images included in the drawing commands, the controller 30 calculates an area enclosed by an outer frame of the recording sheet P regardless of whether or not a toner image is formed within the outer frame. With respect to borders (e.g., grid lines) within which no toner image is formed, the controller 30 divides the borders and calculates an area defined by the divided borders.

As illustrated in FIGS. 4A, 4B, 4C, 4D, and 4E, the image area rate defines a rate of an imaging region on a single page. FIG. 4A illustrates four regions including figures that have different halftone densities, respectively. Each of the four regions has an image area rate of 5%. Since the figures have the different halftone densities, respectively, the figures have different amounts of toner, respectively. However, since a toner image is formed in pixel units, a total image area rate is 20%. FIG. 4B illustrates square figures that form a grid and define an image area rate of 50%. FIG. 4C illustrates a halftone image and a region in which no toner image is formed on paper as the recording sheet P. However, like the figures depicted in FIG. 4A, since a toner image is formed in pixel units, the toner image defines an image area rate of 100%. FIG. 4D illustrates a solid image formed of toner in each pixel at 100%. Hence, the solid image defines an image area rate of 100%. FIG. 4E illustrates an image framed with borders. No image is formed in an interior region enclosed by the borders. The interior region and the borders define an image area rate of 100%. However, the borders are divided to calculate an image area rate of 1%. Each of FIGS. 4A, 4B, 4C, 4D, and 4E illustrates an outer frame that defines a region on a single page.

FIG. 5 illustrates characters defining an image area rate of 30% with respect to an area enclosed by an outer frame regardless of a type of the characters. For example, even complex Chinese characters and characters in boldface mostly define an image area rate of 30% or smaller. In a case that the controller 30 analyzes the characters precisely to calculate an image area rate, the controller 30 may suffer from an increased load. Hence, the characters preferably define the image area rate of 30% uniformly.

In step S103, the controller 30 determines whether or not the image area rate on the page is 50% or more. In a case that the controller 30 determines that the image area rate on the page is 50% or more (YES in step S103), the controller 30 proceeds to step S104. In a case that the controller 30 determines that the image area rate on the page is smaller than 50% (NO in step S103), the controller 30 proceeds to step S105.

In step S104, as the image area rate on the page is 50% or more, the engine control unit 32 depicted in FIG. 2 determines a preset fixing temperature (e.g., a target fixing temperature) of 160 degrees Celsius.

In step S105, the controller 30 determines whether or not the image area rate on the page is 20% or more and is smaller than 50%. In a case that the controller 30 determines that the image area rate on the page is 20% or more and is smaller than 50% (YES in step S105), the controller 30 proceeds to step S106. In a case that the controller 30 determines that the image area rate on the page is smaller than 20% (NO in step S105), the controller 30 proceeds to step S107.

In step S106, as the image area rate on the page is 20% or more and is smaller than 50%, the engine control unit 32 depicted in FIG. 2 determines a preset fixing temperature (e.g., a target fixing temperature) of 158 degrees Celsius.

In step S107, the controller 30 determines whether or not the image area rate on the page is 5% or more and is smaller than 20%. In a case that the controller 30 determines that the image area rate on the page is 5% or more and is smaller than 20% (YES in step S107), the controller 30 proceeds to step S108. In a case that the controller 30 determines that the image area rate on the page is smaller than 5% (NO in step S107), the controller 30 proceeds to step S109.

In step S108, as the image area rate on the page is 5% or more and is smaller than 20%, the engine control unit 32 depicted in FIG. 2 determines a preset fixing temperature (e.g., a target fixing temperature) of 156 degrees Celsius.

In step S109, as the image area rate on the page is smaller than 5%, the engine control unit 32 depicted in FIG. 2 determines a preset fixing temperature (e.g., a target fixing temperature) of 154 degrees Celsius.

In step S110, at the preset fixing temperature determined in one of steps S104, S106, S108, and S109, the controller 30 starts printing according to the print job received from the PC 20 depicted in FIG. 2.

Each of the preset fixing temperatures set in steps S104, S106, S108, and S109 is one example. Alternatively, the controller 30 may set temperatures that are higher or lower than the preset fixing temperatures specified in steps S104, S106, S108, and S109 according to the image area rate. The engine control unit 32 depicted in FIG. 2 controls the preset fixing temperature of the fixing device 18 based on the image area rate on the page.

A description is provided of a control method performed by the image forming apparatus 100 according to a second embodiment of the present disclosure.

Before the image forming apparatus 100 starts printing, the image forming apparatus 100 according to the second embodiment of the present disclosure determines whether or not a print job instructs formation of a halftone image or a continuous-tone image (e.g., a color image and a grayscale image) on a page. In the present disclosure, the continuous-tone image includes characters in addition to photographs and pictures. The image forming apparatus 100 determines the preset fixing temperature of the fixing device 18 based on the image area rate on the page and a determination result of whether or not the print job instructs formation of the halftone image or the continuous-tone image on the page.

The halftone image defines a toner image that does not have a toner coverage ratio per pixel of 100%. The continuous-tone image defines a toner image partially including photographs and images formed in formats such as BMP, GIF, TIFF, JPEG, PNG, RAW, and SVG on a single page as illustrated in FIG. 5. The continuous-tone image includes colors and densities that vary in pixel units. Thus, the continuous-tone image also defines a group of halftone dots.

The halftone image and the continuous-tone image define the toner coverage ratio per pixel that is not 100%. Accordingly, toner particles adhere to each other in the in-plane direction on paper as the recording sheet P with a decreased adhesion force. Consequently, the fixing device 18 fixes the halftone image and the continuous-tone image on the recording sheet P with degraded quality compared to the solid image defining the toner coverage ratio of 100%. Hence, in a case that the print job includes formation of the halftone image or the continuous-tone image, the controller 30 does not change the preset fixing temperature preferably.

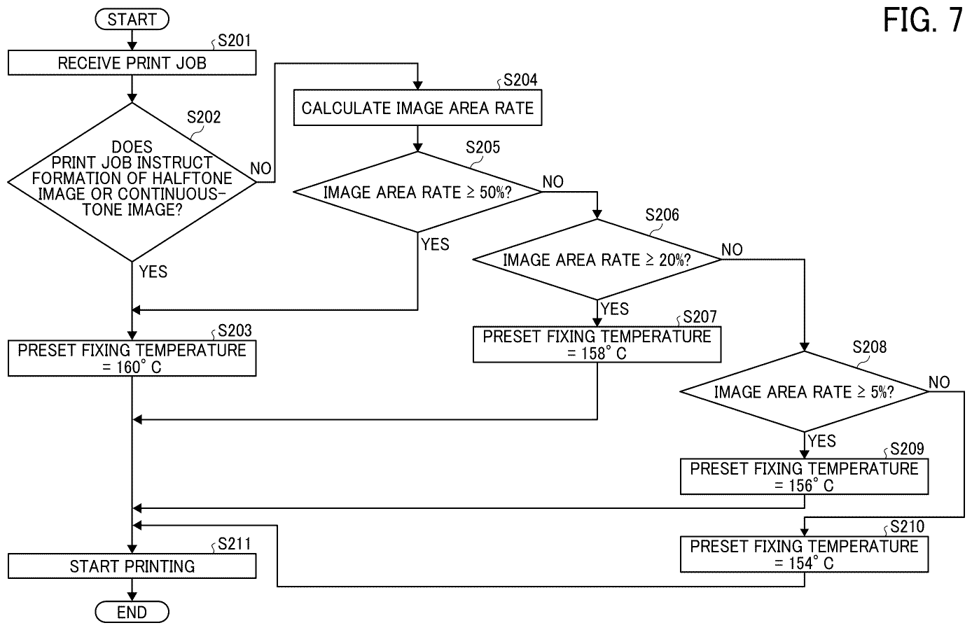

FIG. 7 is a flowchart of processes of a control method performed by the image forming apparatus 100 according to the second embodiment of the present disclosure, as one example. The image forming apparatus 100 according to the second embodiment of the present disclosure starts printing after steps S201 to S210.

The image forming apparatus 100 according to the second embodiment of the present disclosure performs the control method that includes a process for determining whether or not the print job instructs formation of a halftone image or a continuous-tone image in addition to the processes of the control method performed by the image forming apparatus 100 according to the first embodiment.

In step S201, the controller 30 depicted in FIG. 2 receives a print job. In step S202, the controller 30 determines whether the print job instructs formation of a halftone image or a continuous-tone image on a page of a recording sheet P according to image data.

In a case that the controller 30 determines that the print job instructs formation of the halftone image or the continuous-tone image on the page of the recording sheet P (YES in step S202), the engine control unit 32 depicted in FIG. 2 determines a preset fixing temperature (e.g., a target fixing temperature) of 160 degrees Celsius in step S203.

In a case that the controller 30 determines that the print job does not instruct formation of the halftone image or the continuous-tone image on the page of the recording sheet P (NO in step S202), the controller 30 calculates the image area rate on the page according to the image data in step S204.

In step S205, the controller 30 determines whether or not the image area rate on the page is 50% or more. In a case that the controller 30 determines that the image area rate on the page is 50% or more (YES in step S205), the controller 30 proceeds to step S203. In a case that the controller 30 determines that the image area rate on the page is smaller than 50% (NO in step S205), the controller 30 proceeds to step S206.

In step S206, the controller 30 determines whether or not the image area rate on the page is 20% or more and is smaller than 50%. In a case that the controller 30 determines that the image area rate on the page is 20% or more and is smaller than 50% (YES in step S206), the controller 30 proceeds to step S207. In a case that the controller 30 determines that the image area rate on the page is smaller than 20% (NO in step S206), the controller 30 proceeds to step S208.

In step S207, as the image area rate on the page is 20% or more and is smaller than 50%, the engine control unit 32 depicted in FIG. 2 determines a preset fixing temperature (e.g., a target fixing temperature) of 158 degrees Celsius.

In step S208, the controller 30 determines whether or not the image area rate on the page is 5% or more and is smaller than 20%. In a case that the controller 30 determines that the image area rate on the page is 5% or more and is smaller than 20% (YES in step S208), the controller 30 proceeds to step S209. In a case that the controller 30 determines that the image area rate on the page is smaller than 5% (NO in step S208), the controller 30 proceeds to step S210.

In step S209, as the image area rate on the page is 5% or more and is smaller than 20%, the engine control unit 32 depicted in FIG. 2 determines a preset fixing temperature (e.g., a target fixing temperature) of 156 degrees Celsius.

In step S210, as the image area rate on the page is smaller than 5%, the engine control unit 32 depicted in FIG. 2 determines a preset fixing temperature (e.g., a target fixing temperature) of 154 degrees Celsius.

In step S211, at the preset fixing temperature determined in one of steps S203, S207, S209, and S210, the controller 30 starts printing according to the print job received from the PC 20 depicted in FIG. 2.

Each of the preset fixing temperatures set in steps S203, S207, S209, and S210 is one example. Alternatively, the controller 30 may set temperatures that are higher or lower than the preset fixing temperatures specified in steps S203, S207, S209, and S210 according to the image area rate and formation of the halftone image or the continuous-tone image. The engine control unit 32 depicted in FIG. 2 controls the preset fixing temperature of the fixing device 18 based on the image area rate and formation of the halftone image or the continuous-tone image.

A description is provided of a control method performed by the image forming apparatus 100 according to a third embodiment of the present disclosure.

Before the image forming apparatus 100 starts printing, the image forming apparatus 100 according to the third embodiment of the present disclosure determines a thickness of a recording sheet P serving as a recording medium. The image forming apparatus 100 determines the preset fixing temperature of the fixing device 18 based on the image area rate on the page and the thickness (e.g., a paper weight) of the recording sheet P.

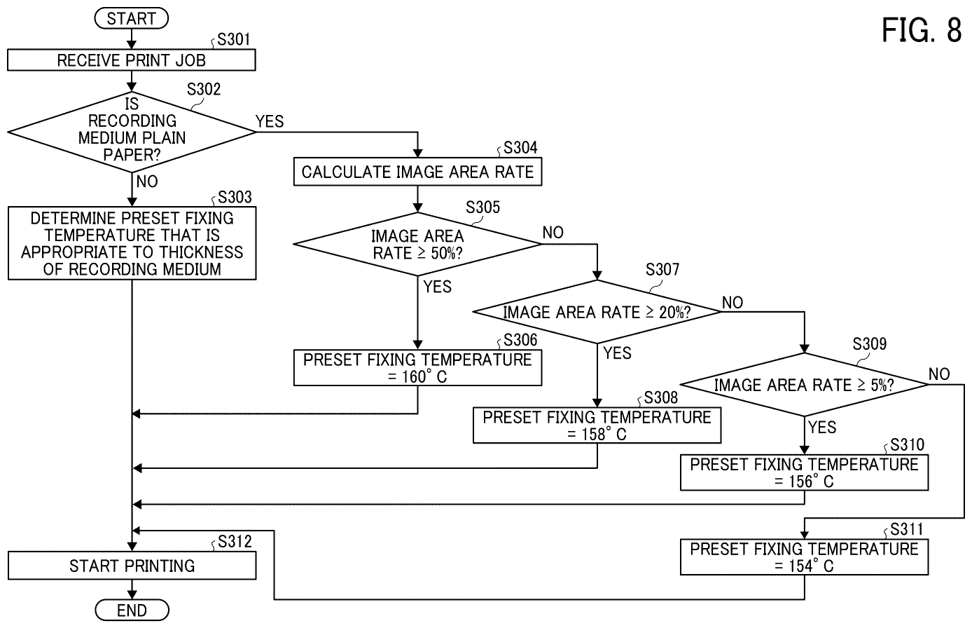

FIG. 8 is a flowchart of processes of the control method performed by the image forming apparatus 100 according to the third embodiment of the present disclosure, as one example. The image forming apparatus 100 according to the third embodiment of the present disclosure starts printing after steps S301 to S311.

The image forming apparatus 100 according to the third embodiment of the present disclosure performs the control method that includes a process for determining whether or not the print job instructs a plain paper mode in addition to the processes of the control method performed by the image forming apparatus 100 according to the first embodiment. Multifunction peripherals (MFPs) and printers frequently use plain paper serving as recording media. The plain paper has a thickness defined by a paper weight in a range of from 50 g/m² to 90 g/m². The MFPs and the printers mostly set different preset fixing temperatures to thicknesses of recording media other than plain paper. Hence, in modes other than the plain paper mode, the image forming apparatus 100 does not calculate the image area rate and sets preset fixing temperatures that are appropriate to the thicknesses of the recording media, respectively, thus attaining proper fixing of the fixing device 18.

In step S301, like in step S101, as the controller 30 depicted in FIG. 2 receives a print job from the PC 20, the controller 30 reads and analyzes image data of the print job so that the image forming apparatus 100 depicted in FIG. 1 forms a toner image on a recording sheet P.

In step S302, the controller 30 determines whether or not the recording sheet P serving as the recording medium is plain paper. In a case that the controller 30 determines that the recording sheet P is not the plain paper (NO in step S302), the controller 30 proceeds to step S303. In a case that the controller 30 determines that the recording sheet P is the plain paper (YES in step S302), the controller 30 proceeds to step S304.

In step S303, as the recording sheet P is not the plain paper, the engine control unit 32 depicted in FIG. 2 determines a preset fixing temperature (e.g., a target fixing temperature) that is appropriate to a thickness of the recording sheet P.

In step S304, the controller 30 calculates the image area rate on the page according to the image data.

In step S305, the controller 30 determines whether or not the image area rate on the page is 50% or more. In a case that the controller 30 determines that the image area rate on the page is 50% or more (YES in step S305), the controller 30 proceeds to step S306. In a case that the controller 30 determines that the image area rate on the page is smaller than 50% (NO in step S305), the controller 30 proceeds to step S307.

In step S306, as the image area rate on the page is 50% or more, the engine control unit 32 depicted in FIG. 2 determines a preset fixing temperature (e.g., a target fixing temperature) of 160 degrees Celsius.

In step S307, the controller 30 determines whether or not the image area rate on the page is 20% or more and is smaller than 50%. In a case that the controller 30 determines that the image area rate on the page is 20% or more (YES in step S307), the controller 30 proceeds to step S308. In a case that the controller 30 determines that the image area rate on the page is smaller than 20% (NO in step S307), the controller 30 proceeds to step S309.

In step S308, as the image area rate on the page is 20% or more and is smaller than 50%, the engine control unit 32 depicted in FIG. 2 determines a preset fixing temperature (e.g., a target fixing temperature) of 158 degrees Celsius.

In step S309, the controller 30 determines whether or not the image area rate on the page is 5% or more and is smaller than 20%. In a case that the controller 30 determines that the image area rate on the page is 5% or more and is smaller than 20% (YES in step S309), the controller 30 proceeds to step S310. In a case that the controller 30 determines that the image area rate on the page is smaller than 5% (NO in step S309), the controller 30 proceeds to step S311.

In step S310, as the image area rate on the page is 5% or more and is smaller than 20%, the engine control unit 32 depicted in FIG. 2 determines a preset fixing temperature (e.g., a target fixing temperature) of 156 degrees Celsius.

In step S311, as the image area rate on the page is smaller than 5%, the engine control unit 32 depicted in FIG. 2 determines a preset fixing temperature (e.g., a target fixing temperature) of 154 degrees Celsius.

In step S312, at the preset fixing temperature determined in one of steps S303, S306, S308, S310, and S311, the controller 30 starts printing according to the print job received from the PC 20 depicted in FIG. 2.

Each of the preset fixing temperatures set in steps S303, S306, S308, S310, and S311 is one example. Alternatively, the controller 30 may set temperatures that are higher or lower than the preset fixing temperatures specified in steps S303, S306, S308, S310, and S311 according to the image area rate and the thickness of the recording sheet P. The engine control unit 32 depicted in FIG. 2 controls the preset fixing temperature of the fixing device 18 based on the image area rate on the page and the thickness of the recording sheet P.

A description is provided of a control method performed by the image forming apparatus 100 according to a fourth embodiment of the present disclosure.

Before the image forming apparatus 100 starts printing, the image forming apparatus 100 according to the fourth embodiment of the present disclosure determines a size of a recording sheet P serving as a recording medium. The image forming apparatus 100 determines the preset fixing temperature at which the fixing device 18 fixes a toner image on the recording sheet P based on the image area rate on the page and the size of the recording sheet P.

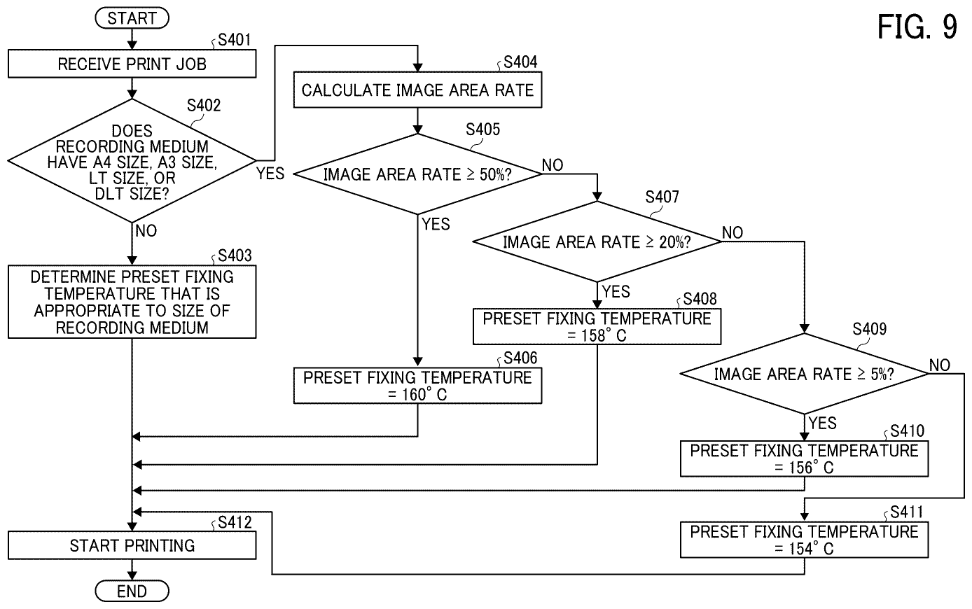

FIG. 9 is a flowchart of processes of the control method performed by the image forming apparatus 100 according to the fourth embodiment of the present disclosure, as one example. The image forming apparatus 100 according to the fourth embodiment of the present disclosure starts printing after steps S401 to S411.

The image forming apparatus 100 according to the fourth embodiment of the present disclosure performs the control method that includes a process for determining the size of the recording sheet P in addition to the processes of the control method performed by the image forming apparatus 100 according to the first embodiment. The MFPs and the printers frequently use the recording sheets P having an A4 size, an A3 size, a letter (LT) size, and a double letter (DLT) size (e.g., a tabloid size and a ledger size). The MFPs and the printers are mostly designed to print properly on the recording sheets P having the frequently used sizes described above. The MFPs and the printers may include a heater that employs a heat generation span and a temperature control method that are not appropriate to sizes other than the frequently used sizes described above. Hence, with respect to the sizes other than the frequently used sizes described above, the image forming apparatus 100 does not calculate the image area rate and sets a preset fixing temperature (e.g., a target fixing temperature) that is appropriate to each of the sizes of the recording sheets P, thus attaining proper fixing of the fixing device 18 preferably.

In step S401, like in step S101, as the controller 30 depicted in FIG. 2 receives a print job from the PC 20, the controller 30 reads and analyzes image data of the print job so that the image forming apparatus 100 depicted in FIG. 1 forms a toner image on a recording sheet P.

In step S402, the controller 30 determines whether or not the recording sheet P serving as a recording medium has one of the A4 size, the A3 size, the LT size, and the DLT size. In a case that the controller 30 determines that the recording sheet P does not have one of the A4 size, the A3 size, the LT size, and the DLT size (NO in step S402), the controller 30 proceeds to step S403. In a case that the controller 30 determines that the recording sheet P has one of the A4 size, the A3 size, the LT size, and the DLT size (YES in step S402), the controller 30 proceeds to step S404.

In step S403, as the recording sheet P does not have one of the A4 size, the A3 size, the LT size, and the DLT size, the engine control unit 32 depicted in FIG. 2 determines a preset fixing temperature (e.g., a target fixing temperature) that is appropriate to a size of the recording sheet P.

In step S404, the controller 30 calculates the image area rate on the page according to the image data.

In step S405, the controller 30 determines whether or not the image area rate on the page is 50% or more. In a case that the controller 30 determines that the image area rate on the page is 50% or more (YES in step S405), the controller 30 proceeds to step S406. In a case that the controller 30 determines that the image area rate on the page is smaller than 50% (NO in step S405), the controller 30 proceeds to step S407.

In step S406, as the image area rate on the page is 50% or more, the engine control unit 32 depicted in FIG. 2 determines a preset fixing temperature (e.g., a target fixing temperature) of 160 degrees Celsius.

In step S407, the controller 30 determines whether or not the image area rate on the page is 20% or more and is smaller than 50%. In a case that the controller 30 determines that the image area rate on the page is 20% or more (YES in step S407), the controller 30 proceeds to step S408. In a case that the controller 30 determines that the image area rate on the page is smaller than 20% (NO in step S407), the controller 30 proceeds to step S409.

In step S408, as the image area rate on the page is 20% or more and is smaller than 50%, the engine control unit 32 depicted in FIG. 2 determines a preset fixing temperature (e.g., a target fixing temperature) of 158 degrees Celsius.

In step S409, the controller 30 determines whether or not the image area rate on the page is 5% or more and is smaller than 20%. In a case that the controller 30 determines that the image area rate on the page is 5% or more and is smaller than 20% (YES in step S409), the controller 30 proceeds to step S410. In a case that the controller 30 determines that the image area rate on the page is smaller than 5% (NO in step S409), the controller 30 proceeds to step S411.

In step S410, as the image area rate on the page is 5% or more and is smaller than 20%, the engine control unit 32 depicted in FIG. 2 determines a preset fixing temperature (e.g., a target fixing temperature) of 156 degrees Celsius.

In step S411, as the image area rate on the page is smaller than 5%, the engine control unit 32 depicted in FIG. 2 determines a preset fixing temperature (e.g., a target fixing temperature) of 154 degrees Celsius.

In step S412, at the preset fixing temperature determined in one of steps S403, S406, S408, S410, and S411, the controller 30 starts printing according to the print job received from the PC 20 depicted in FIG. 2.

Each of the preset fixing temperatures set in steps S403, S406, S408, S410, and S411 is one example. Alternatively, the controller 30 may set temperatures that are higher or lower than the preset fixing temperatures specified in steps S403, S406, S408, S410, and S411 according to the image area rate and the size of the recording sheet P. The engine control unit 32 depicted in FIG. 2 controls the preset fixing temperature of the fixing device 18 based on the image area rate on the page and the size of the recording sheet P.

A description is provided of aspects of the embodiments of the present disclosure.

A description is provided of a first aspect of the embodiments of the present disclosure.

An image forming apparatus (e.g., the image forming apparatus 100) transfers and fixes toner onto a recording medium (e.g., the recording sheet P) to form a toner image on the recording medium. The image forming apparatus includes a controller (e.g., the controller 30) and a fixing device (e.g., the fixing device 18). The controller includes processing circuitry.

The controller receives and analyzes print data in a monochrome mode, that includes a drawing command, to generate image data. The controller controls the fixing device according to the image data. The fixing device fixes the toner image on the recording medium according to the image data generated by the controller.

The controller calculates an image area rate per page of the recording medium based on the print data in the monochrome mode. In a case that the controller determines that the image area rate is not greater than a predetermined value, the controller determines a preset fixing temperature (e.g., a target fixing temperature) of the fixing device according to the image area rate.

A description is provided of a second aspect of the embodiments of the present disclosure.

In the image forming apparatus according to the first aspect, the drawing command includes formation of at least one of a character, a graphic, or an image. The controller calculates an area of the character, the graphic, or the image specified by the drawing command as an area enclosed by an outer frame of the at least one of the character, the graphic, or the image. In a case that no toner image is formed within the outer frame of the page and borders are formed within the outer frame of the page, the controller calculates the area by dividing the borders.

A description is provided of a third aspect of the embodiments of the present disclosure.

In the image forming apparatus according to the second aspect, the controller calculates an image area rate of the character, that has the predetermined value.

A description is provided of a fourth aspect of the embodiments of the present disclosure.

In the image forming apparatus according to any one of the first aspect to the third aspect, in a case that the controller determines that at least one of a halftone image or a continuous-tone image is formed on the page, the controller does not change, that is, retains, the preset fixing temperature of the fixing device.

A description is provided of a fifth aspect of the embodiments of the present disclosure.

In the image forming apparatus according to any one of the first aspect to the fourth aspect, before the fixing device fixes the toner image on the recording medium, the controller determines that the recording medium is plain paper that has a thickness defined by a paper weight not smaller than 50 g/m² and not greater than 90 g/m². The controller changes the preset fixing temperature of the fixing device based on the image area rate and the thickness of the recording medium.

A description is provided of a sixth aspect of the embodiments of the present disclosure.

In the image forming apparatus according to any one of the first aspect to the fifth aspect, before the fixing device fixes the toner image on the recording medium, the controller determines that the recording medium has one of an A4 size, a letter (LT) size, an A3 size, and a double letter (DLT) size (e.g., a tabloid size and a ledger size). The controller changes the preset fixing temperature of the fixing device based on the image area rate and the size of the recording medium.

Accordingly, the image forming apparatus suppresses generation of fine particles and reduces curling (e.g., warpage) of the recording medium while improving energy saving.

According to the embodiments described above, the image forming apparatus 100 is a multifunction peripheral (MFP) having at least two of copying, printing, scanning, facsimile, and plotter functions. Alternatively, the image forming apparatus 100 may be a copier, a printer, a facsimile machine, or the like.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
a fixing device to fix toner on a recording medium to form a toner image; and
processing circuitry configured to:
receive and analyze print data in a monochrome mode to generate image data, the print data including a drawing command;
calculate an image area rate per page of the recording medium based on the print data in the monochrome mode;
determine that the image area rate is not greater than a predetermined value;
determine a preset fixing temperature of the fixing device according to the image area rate; and
control the fixing device to fix the toner on the recording medium according to the image data.

2. The image forming apparatus according to p 1,
wherein the drawing command includes formation of at least one of a character, a graphic, or an image, and
wherein the processing circuitry is configured to calculate an area of the at least one of the character, the graphic, or the image as an area enclosed by an outer frame of the at least one of the character, the graphic, or the image.

3. The image forming apparatus according to claim 2,
wherein the processing circuitry is configured to:
determine that no toner image is formed within the outer frame of the page;
determine that borders are formed within the outer frame of the page; and
calculate the area by dividing the borders.

4. The image forming apparatus according to claim 3,
wherein the processing circuitry is configured to calculate the image area rate of the character, the image area rate having the predetermined value.

5. The image forming apparatus according to claim 1,
wherein the processing circuitry is configured to:
determine that at least one of a halftone image or a continuous-tone image is formed on a page of the recording medium; and
retain the preset fixing temperature of the fixing device.

6. The image forming apparatus according to claim 1,
wherein the processing circuitry is configured to:
determine that the recording medium has a thickness defined by a paper weight that is not smaller than 50 g/m² and not greater than 90 g/m² before the fixing device fixes the toner on the recording medium; and
change the preset fixing temperature of the fixing device based on the image area rate and the thickness of the recording medium.

7. The image forming apparatus according to claim 6,
wherein the processing circuitry is configured to determine that the recording medium is plain paper.

8. The image forming apparatus according to claim 1,
wherein the processing circuitry is configured to:
determine that the recording medium has one of an A4 size, a letter size, an A3 size, a tabloid size, and a ledger size before the fixing device fixes the toner on the recording medium; and
change the preset fixing temperature of the fixing device based on the image area rate and the size of the recording medium.

9. An image forming apparatus comprising:
fixing means for fixing toner on a recording medium to form a toner image; and
control means for:
receiving and analyzing print data in a monochrome mode to generate image data, the print data including a drawing command;
calculating an image area rate per page of the recording medium based on the print data in the monochrome mode;
determining that the image area rate is not greater than a predetermined value;
determining a preset fixing temperature of the fixing means according to the image area rate; and
controlling the fixing means to fix the toner on the recording medium according to the image data.

10. An image forming method comprising:
reading and analyzing print data;
calculating an image area rate per page of a recording medium based on the print data;
determining that the image area rate is not greater than a predetermined value;
determining a preset fixing temperature at which a toner image is fixed on the recording medium according to the image area rate; and
starting printing at the preset fixing temperature.
